(19) United States
(12) Patent Application Publication
(10) Pub. No.: US 2024/0415161 A1
(43) Pub. Date: Dec. 19, 2024

(54) Dietary Supplement

(71) Applicants: Mary Frances Rabito, Covington, LA (US); Felix Rabito, Covington, LA (US); Tom De Brock, Mandeville, LA (US); Kimberly De Brock, Mandeville, LA (US)

(72) Inventors: Mary Frances Rabito, Covington, LA (US); Felix Rabito, Covington, LA (US); Tom De Brock, Mandeville, LA (US); Kimberly De Brock, Mandeville, LA (US)

(21) Appl. No.: 18/745,765

(22) Filed: Jun. 17, 2024

Related U.S. Application Data
(60) Provisional application No. 63/521,235, filed on Jun. 15, 2023.

(51) Int. Cl. A23L 33/22; A23G 1/48; A23G 3/48; A23L 7/10; A23L 33/125

(52) U.S. Cl. CPC A23L 33/22; A23G 1/48; A23G 3/48; A23L 7/10; A23L 33/125

(57) ABSTRACT

In accordance with embodiments of the invention, a dose of a dietary supplement for digestive health is provided. In one embodiment, the dose comprises 40%-50% base by weight, 2-3% oil by weight, 2-3% syrup by weight, 4-6% grain by weight, and 37.5-47.5% psyllium husk by weight. In another embodiment, the dose comprises 55%-57.5% base by weight, 2-3% oil by weight, 2-3% syrup by weight, 5.75-6.25% grain by weight, and 30-32.5% psyllium husk by weight. In yet another embodiment, the dose comprises 40%-50% base by weight, 2-3% oil by weight, 2-3% syrup by weight, 4.75-5% grain by weight, and 32.5-40% psyllium husk by weight. In some embodiments, inulin may be included in ranges of 7.5-7.75% or 14-14.25%.

### CROSS-REFERENCE TO RELATED APPLICATIONS

This application claims priority to U.S. Provisional Patent Application Ser. No. 63/521,235, filed Jun. 15, 2023, the entirety of which is incorporated by reference as if fully disclosed herein.

### BACKGROUND OF THE INVENTION

### I. Field of the Invention

The present invention relates generally to dietary supplements for digestive health.

### II. General Background

Fiber is necessary for bowel health. Fiber assists with bowel movements to decrease constipation and hemorrhoid issues by promoting regular bowel movements. Fiber also serves as a probiotic, which encourages the proliferation of healthy bowel flora. Fiber also improves symptoms of irritable bowel syndrome (IBS), as well as lowering cholesterol. Fiber can also promote weight loss and improve blood pressure. Because of these benefits, fiber derived from psyllium husks is frequently taken as a supplement. However, fiber supplements are gritty and have slightly bitter flavors. Accordingly, what is needed is a dietary supplement containing fiber that has an appealing flavor and texture.

### SUMMARY OF THE INVENTION

In accordance with embodiments of the invention, a dose of a dietary supplement for digestive health is provided. In one embodiment, the dose comprises 45%-50% base by weight, 2-3% oil by weight, 2-3% syrup by weight, 5-5.5% grain by weight, and 40-42.5% psyllium husk by weight.

In another embodiment, the dose comprises 55%-57.5% base by weight, 2-3% oil by weight, 2-3% syrup by weight, 5.75-6.25% grain by weight, and 30-32.5% psyllium husk by weight.

In yet another embodiment, the dose comprises 40%-50% base by weight, 2-3% oil by weight, 2-3% syrup by weight, 4.75-5% grain by weight, and 32.5-40% psyllium husk by weight. In some embodiments, inulin may be included in ranges of 7.5-7.75% or 14-14.25%.

### DETAILED DESCRIPTION

It will be readily understood that the components could be arranged and designed in a wide variety of different configurations or be entirely separate. Thus, the following more detailed description of the embodiments of the system and method of the disclosure is not intended to limit the scope of the disclosure as claimed but is merely representative of possible embodiments of the disclosure.

In accordance with embodiments of the invention, a dietary supplement for digestive health is provided. In one embodiment, the supplement comprises 283 grams organic chocolate base, 3 teaspoons organic coconut oil, 1 teaspoon maple syrup, 1 cup organic rice crisps or cereal, and 48 teaspoons organic psyllium husks. In some embodiments, the base may be another confection, such as a candy or a white chocolate, and further include a grain, a granola, or any suitable alternative. The maple syrup may be exchanges for any suitable alternative sweetener, such as corn syrup, agave nectar, sugar, or the like. The rice crisps or cereal may be replaced by any type of grain cereal, for example.

The dosage of fiber per serving can be varied by adjusting the amount of organic psyllium husks included in the invention, such as lowering the amount from 48 teaspoons to 32 teaspoons. To reduce a gritty texture, the psyllium is ground to a fine consistency, such as 6 grams per teaspoon. One gram of fiber is contained in each ½ teaspoon of psyllium. Thus, an embodiment including 48 teaspoons of psyllium contains 96 grams of fiber. The supplement can be cut into pieces (for example, 16 pieces) to create individual serving sized portions (for example, portions that each contain 6 grams of fiber per serving). While an exemplary ratio of 1 gram of fiber per 3 grams of ground psyllium husk is used herein, the invention contemplates the use of available psyllium products that may have different densities, purities or may contain different amounts of fiber. The ratios of ingredients of the dietary supplement invention may be modified to accommodate the different qualities of available psyllium ingredient products to achieve a dietary supplement with a desired amount of fiber; for example, three, six, nine, twelve or fifteen grams of fiber.

In accordance with embodiments of the invention, a method of manufacturing a dietary supplement 100 for digestive health is provided. The method includes a first step of grinding organic psyllium to a fine consistency. The method includes a second step of melting 283 grams of organic chocolate to a fluid consistency. The method includes a third step of combining the melted organic chocolate with 3 teaspoons of organic coconut oil. The method includes a fourth step of combining 32 teaspoons (64 grams of fiber) or 48 teaspoons (96 grams of fiber) of the ground organic psyllium with 1 cup of organic rice crisps. The method includes a fifth step of forming a mixture by mixing the products of the previous steps with 1 teaspoon of maple syrup. The method includes a sixth step of spreading the mixture formed in step on a sheet pan lined with parchment paper to an even thickness over an 8 in×13 in surface. The method includes a seventh step of freezing the mixture for 15 minutes to solidify. The method includes an eighth step of cutting the solidified mixture into 16 even pieces to form individual portions. When cut into 16 pieces, the dosage of fiber per serving is 6 grams when 48 teaspoons of the ground organic psyllium are used in the fourth step and 4 grams when 32 teaspoons of the ground organic psyllium are used in the fourth step.

While psyllium husks are an important fiber bulking agent that provides many benefits as an ingredient of digestive health dietary supplements, the presence of large amounts of psyllium in a food product may produce unappealing, gritty textures for consumers. Attempting to create a high-fiber health supplement using only psyllium may produce undesirable textures, mouthfeel, and/or taste in a food product. Therefore, in some embodiments of the present invention, inulin is used in addition to psyllium to increase the fiber content of the dietary supplement without creating undesirable textures caused by large amounts of psyllium. Inulin includes the additional benefit of stimulating bacterial growth in the gut and aiding in digestive health. Inulin is a type of soluble fiber found in many plants, including chicory root, Jerusalem artichoke, raw asparagus, raw onion pulp, wheat, and raw barley. In some embodiments, the inulin used in the dietary supplement contains 1 gram of fiber per 1 gram of inulin. While an exemplary ratio of 1 gram of fiber per 1 gram of inulin is used herein, the invention contemplates the use of available inulin products that may have different densities or may contain different amounts of fiber. The ratios of ingredients contained in the dietary supplement invention may be modified to accommodate the different qualities of inulin product and to achieve a dietary supplement with a desired amount of fiber; for example, three, six, nine, twelve or fifteen grams of fiber.

As one skilled in the art would understand, the size of the chocolate bars created in the method described above can be varied. The concentration dosage of the psyllium can also be varied by increasing the amount of psyllium or the amount of the other ingredients to strengthen or dilute the concentration of psyllium. For example, two bars in one package with a concentration of 4 g of psyllium in each could be taken once or twice a day, as needed. Further, doses of the supplement may be taken with any liquid beverage, preferably measuring at least 8 oz.

Several exemplary formulations of the supplement that can produce batches of 16 doses are included below. It is assumed that 3 teaspoons of coconut oil weights 13.6 g, 1 cup of grain cereal weighs 30 g, 1 teaspoon of maple syrup weighs 14 g, and 48 teaspoons of psyllium husks weigh 240 g. However, it is understood, and this invention contemplates, that available ingredients may contain varying weights, densities of nutrients, etc. Formulas and ingredients may be adjusted to account for these variances.

Example 1: 6 grams of fiber from psyllium husk

| Ingredient | Grams | Grams Per 1/16 | Percentage |
|---|---|---|---|
| Chocolate | 283 | 17.69 | 45.02% |
| Coconut Oil | 13.65 | 0.85 | 2.17% |
| Maple Syrup | 14 | 0.88 | 2.23% |
| Grain Cereal | 30 | 1.88 | 4.77% |
| Psyllium Husk | 288 | 18.00 | 45.81% |
| Total | 628.65 | 39.29 | 100.00% |

Example 2: 3 grams of fiber from psyllium husk

| Ingredient | Grams | Per 1/16 | Percentage |
|---|---|---|---|
| Chocolate | 283 | 17.69 | 58.39% |
| Coconut Oil | 13.65 | 0.85 | 2.82% |
| Maple Syrup | 14 | 0.88 | 2.89% |
| Grain Cereal | 30 | 1.88 | 6.19% |
| Psyllium Husk | 144 | 9.00 | 29.71% |
| Total | 484.65 | 30.29 | 100.00% |

Example 3: 9 grams of fiber: 6 from
psyllium husk and 3 from inulin

| Ingredient | Grams | Grams Per 1/16 | Percentage |
|---|---|---|---|
| Chocolate | 283 | 17.69 | 41.82% |
| Coconut Oil | 13.65 | 0.85 | 2.02% |
| Maple Syrup | 14 | 0.88 | 2.07% |
| Grain Cereal | 30 | 1.88 | 4.43% |
| Psyllium Husk | 288 | 18.00 | 42.56% |
| Inulin | 48 | 3.00 | 7.09% |
| | 676.65 | 42.29 | 100.00% |

Example 4: 12 grams of fiber: 6 from
psyllium husk and 6 from inulin

| Ingredient | Grams | Grams Per 1/16 | Percentage |
|---|---|---|---|
| Chocolate | 283 | 17.69 | 39.05% |
| Coconut Oil | 13.65 | 0.85 | 1.88% |
| Maple Syrup | 14 | 0.88 | 1.93% |
| Grain Cereal | 30 | 1.88 | 4.14% |
| Psyllium Husk | 288 | 18.00 | 39.74% |
| Inulin | 96 | 6.00 | 13.25% |
| Total | 724.65 | 45.29 | 100.00% |

The specific language in the Detailed Description intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. It should be noted that many alternative or additional functional relationships, physical connections or logical connections may be present in a practical embodiment. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A dietary supplement for digestive health, comprising:
40%-50% base by weight;
1.5-3% oil by weight;
1.5-3% syrup by weight;
4-5.5% grain by weight; and
37.5-47.5% psyllium husk by weight.

2. The dietary supplement of claim 1, wherein the percentage of the base by weight is about 45%, wherein the percentage of oil by weight is about 2%, wherein the percentage of syrup by weight is about 2%, wherein the percentage of grain by weight is about 5%, and wherein the percentage of psyllium husk by weight is about 45% by weight.

3. The dietary supplement of claim 1, wherein the dose of the dietary supplement comprises about 17-18 g chocolate, 0.5-1.0 g oil, 0.5-1.0 g syrup, 1.5-2.0 g grain, and 15-20 g psyllium husks.

4. The dietary supplement of claim 1, wherein the base is chocolate.

5. The dietary supplement of claim 1, wherein the base is a confection.

6. The dietary supplement of claim 1, wherein the base is grain-based.

7. The dietary supplement of claim 1, wherein the syrup is maple syrup, agave nectar, or sugar.

8. The dietary supplement of claim 1, wherein the grain is rice crisps or cereal.

9. A dose of a dietary supplement for digestive health, comprising:
55%-60% base by weight;
2.0-3.5% oil by weight;
2.0-3.5% syrup by weight;
5.5-6.5% grain by weight; and
25-35% psyllium husk by weight.

10. The dietary supplement of claim 9, wherein the percentage of the base by weight is about 41%, wherein the percentage of oil by weight is about 2%, wherein the percentage of syrup by weight is about 2%, wherein the percentage of grain by weight is about 4.5%, and wherein the percentage of psyllium husk by weight is about 42% by weight.

11. The dietary supplement of claim 9, wherein the dose of the dietary supplement comprises about 17-18 g chocolate, 0.5-1.0 g oil, 0.5-1.0 g syrup, 1.5-2.0 g grain, and 15-20 g psyllium husks.

12. A dietary supplement for digestive health, comprising:
35%-45% of a base by weight;
1.0-3.5% oil by weight;
1.0-3.5% sweetener by weight;
4.0-6.0% grain by weight; and
32.5-47.5% psyllium husk by weight.

13. The dietary supplement of claim 12, further comprising 2.5-12.5% inulin by weight.

14. The dietary supplement of claim 13, wherein the percentage of the base by weight is about 45%, wherein the percentage of oil by weight is about 2%, wherein the percentage of syrup by weight is about 2%, wherein the percentage of grain by weight is about 5%, wherein the percentage of psyllium husk by weight is about 38% by weight.

15. The dietary supplement of claim 13, wherein the dose of the dietary supplement comprises about 17-18 g chocolate, 0.5-1.0 g oil, 0.5-1.0 g syrup, 1.5-2.0 g grain, and 15-20 g psyllium husks.

16. The dietary supplement of claim 12, further comprising 10-20% inulin by weight.

17. The dietary supplement of claim 16, wherein the dose of the dietary supplement comprises about 17-18 g chocolate, 0.5-1.0 g oil, 0.5-1.0 g syrup, 1.5-2.0 g grain, and 15-20 g psyllium husks.

18. A dietary supplement for digestive health consisting of: chocolate, oil, maple syrup, grain and psyllium husk.

19. The dietary supplement of claim 18, wherein the dietary supplement further consists of inulin.

20. The dietary supplement of claim 19, wherein the dietary supplement further consists of 1 to 15 grams of fiber.
